(19) United States
(12) Patent Application Publication
(10) Pub. No.: US 2006/0026792 A1
(43) Pub. Date: Feb. 9, 2006

(54) Hinge

(76) Inventors: Klaus Brustle, Hochst (AT); Fredi Dubach, Baretwil (CH)

Correspondence Address: WENDEROTH, LIND & PONACK, L.L.P., 2033 K STREET N. W., SUITE 800, WASHINGTON, DC, 20006-1021, US

(21) Appl. No.: 11/248,256

(22) Filed: Oct. 13, 2005

Related U.S. Application Data
(63) Continuation of application No. PCT/AT04/00126, filed on Apr. 9, 2004.

(30) Foreign Application Priority Data
Apr. 15, 2003 (AT) A 577/2003

(51) Int. Cl. E05F 3/20

(52) U.S. Cl. 16/54

(57) ABSTRACT

Hinge with a hinge cup, which can be inserted into a boring in a furniture part, with a damper housing fixed onto the hinge cup, wherein the damper housing can be fastened onto or removably secured to the hinge cup wherein the damper housing is disposed at least partially outside the boring when the hinge cup is inserted into the boring in the furniture part.

The invention concerns a hinge with a hinge cup which can be inserted into a boring in a furniture part, with a damper housing fixed onto the hinge cup.

Hinges fitted with a damper which brakes furniture doors during closing are known in the art from EP 1 199 433 A2, from the Austrian utility model AT 005 477 U1 and the German utility models DE 201 15 250 U and DE 202 05 905 U. The problem of the invention is to create a hinge with a damper such that the damper can be used universally.

The inventive problem is solved by the fact that the damper housing can be fastened onto or removably secured to the hinge cup wherein the damper housing is disposed at least partially outside the boring when the hinge cup is inserted into the boring in the furniture part.

Advantageously, provision is made for the damper housing to be disposed entirely outside the boring when the hinge cup is inserted into the boring in the furniture part.

A further embodiment of the invention makes provision that the hinge cup has a flange abutting on the furniture doors and that the damper housing is anchored on the flange of the hinge cup.

Next, one embodiment of the invention will be described with the aid of the figures in the attached drawings, which show:

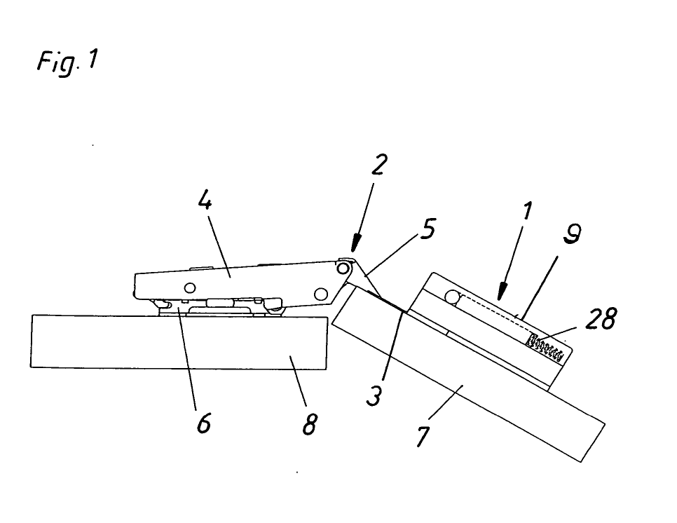

FIG. 1: a lateral view of an inventive hinge equipped with a damper, showing parts of one wall of the body and the door of the furniture,

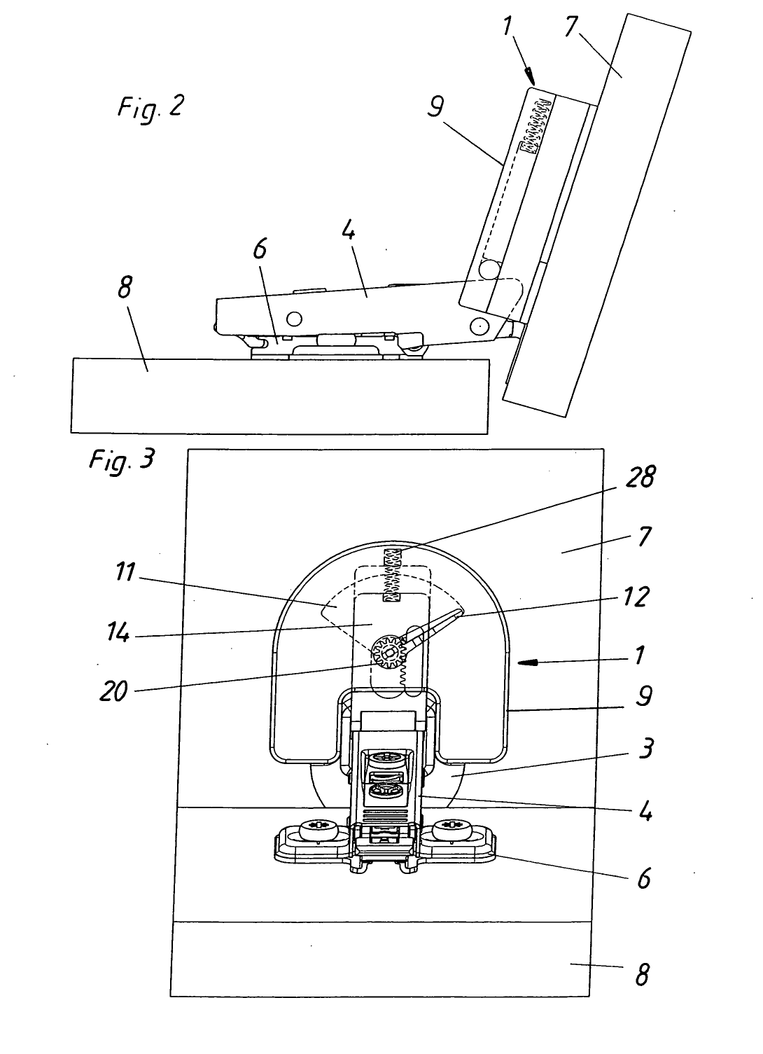

FIG. 2: a lateral view of an inventive hinge with a damper, wherein the hinge is shown at the start of the damping path,

FIG. 3: a top view of a hinge according to FIG. 2,

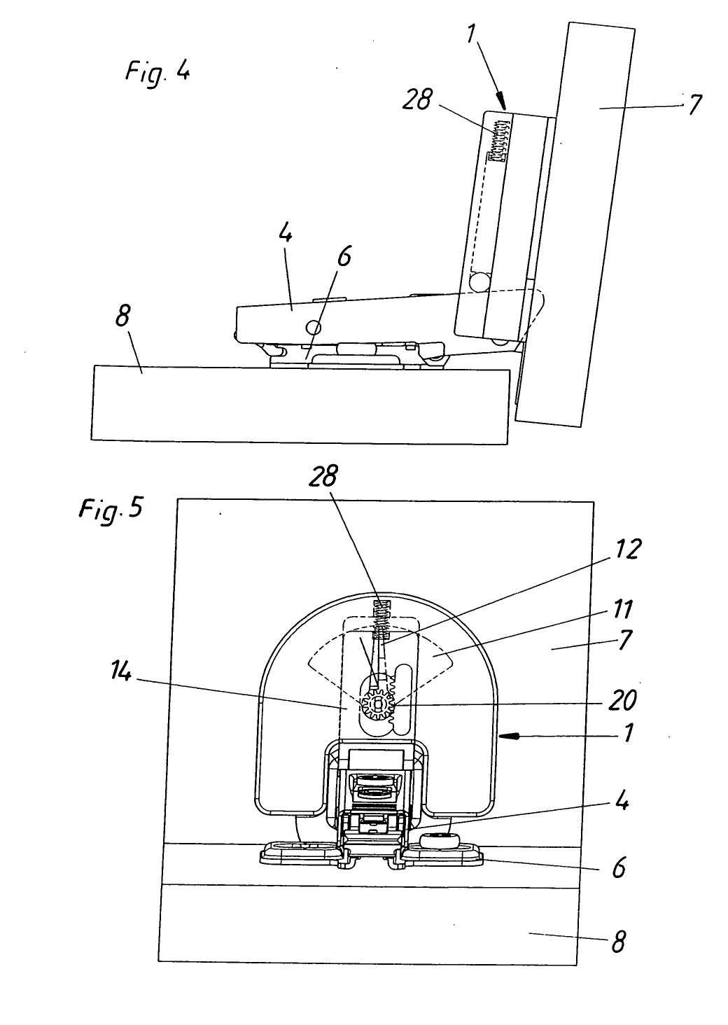

FIG. 4: a lateral view of an inventive hinge with a damper, wherein the hinge is shown in the middle of the damping area,

FIG. 5: a top view of a hinge according to FIG. 4,

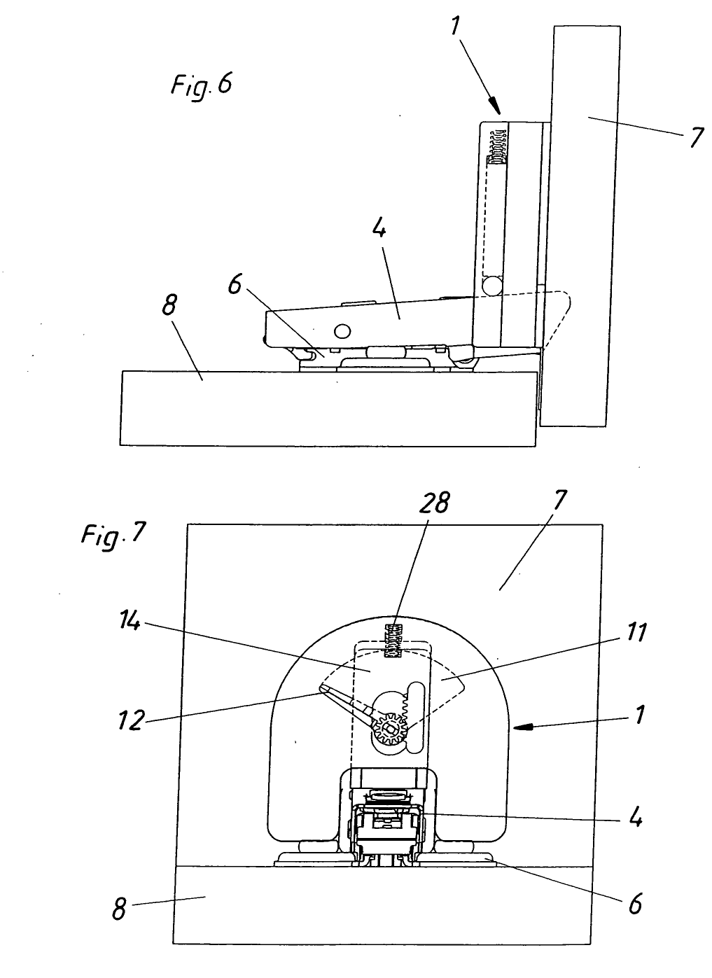

FIG. 6: a lateral view of an inventive hinge with a damper, wherein the hinge is shown in the closed position,

FIG. 7: a top view of a hinge according to FIG. 6,

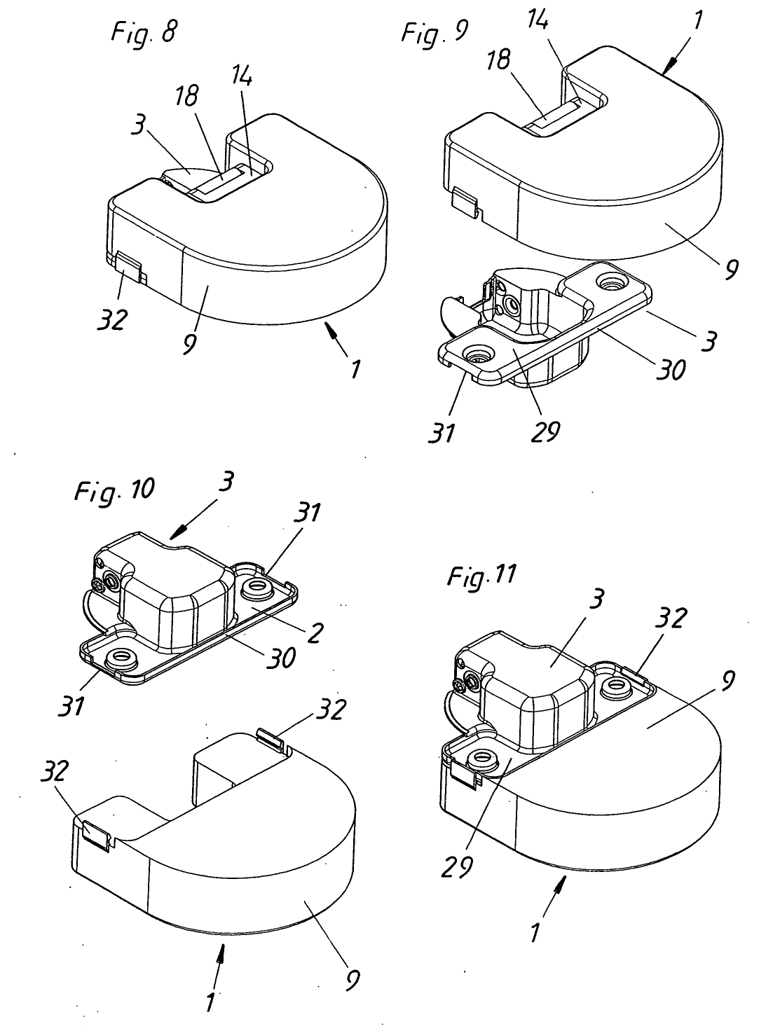

FIG. 8.: a diagram of a damper fixed onto a hinge cup seen from above,

FIG. 9: an exploded diagram of an inventive damper and a hinge cup,

FIG. 10: an exploded diagram of an inventive damper and a hinge cup, wherein the elements are rotated by 180° with respect to FIG. 8,

FIG. 11: a diagram of a hinge cup with the inventive damper,

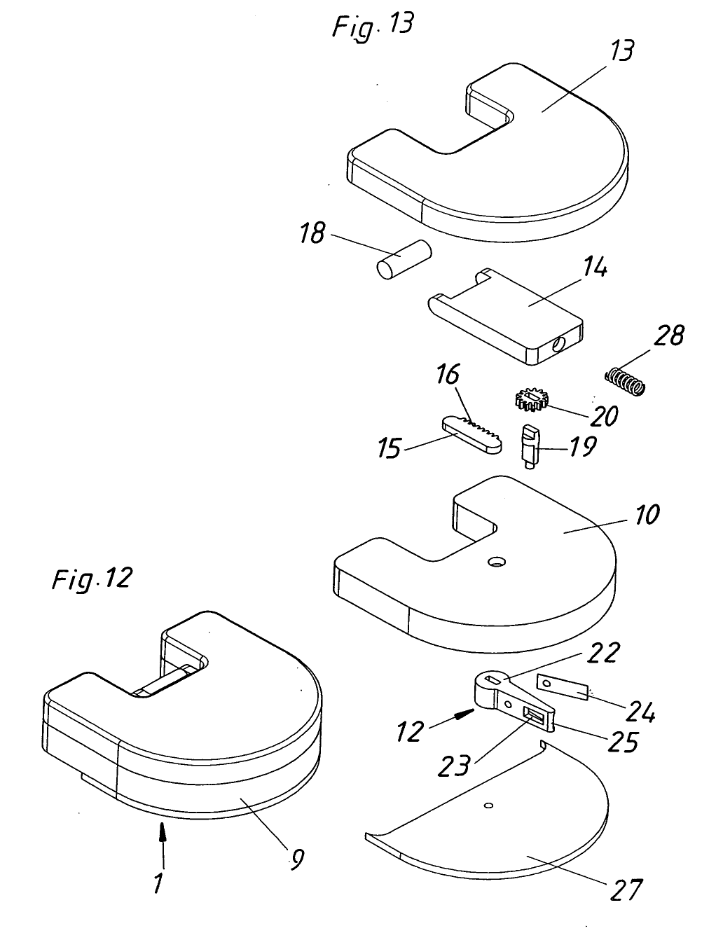

FIG. 12: a diagram of an inventive damper,

FIG. 13: an exploded diagram of an inventive damper,

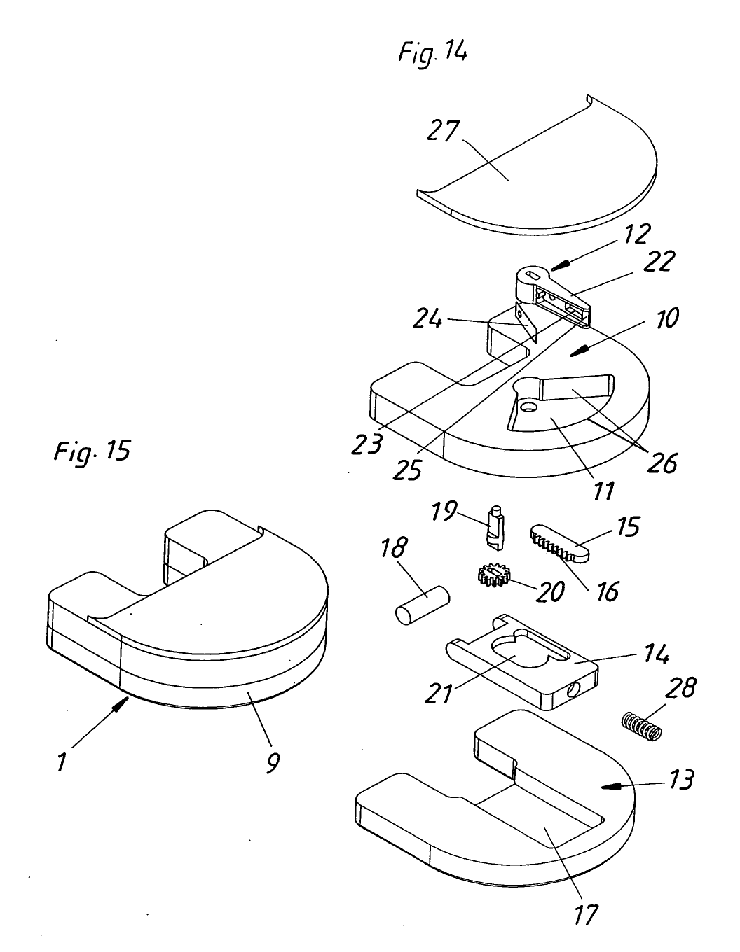

FIG. 14: an exploded diagram of an inventive damper, wherein the elements are shown rotated by 180° with respect to FIG. 13,

FIG. 15: a further diagram of an inventive damper,

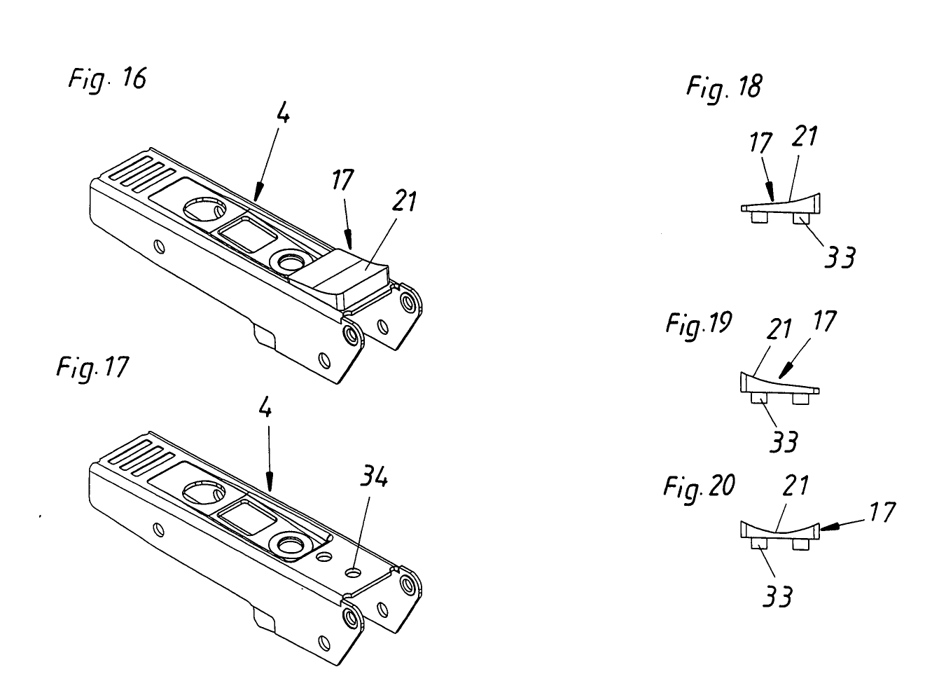

FIG. 16: a diagram of a hinge arm with an attachment,

FIG. 17: a diagram of a hinge arm which is suitable to accept an attachment,

FIGS. 18 to 20: lateral views of an attachment,

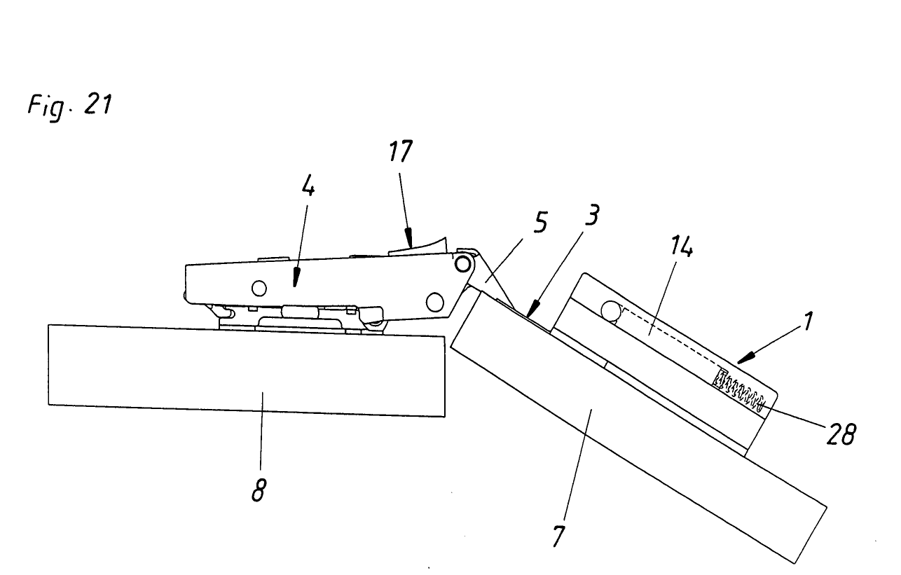

FIG. 21 shows a lateral view of a hinge with attachment attached in the open position, and

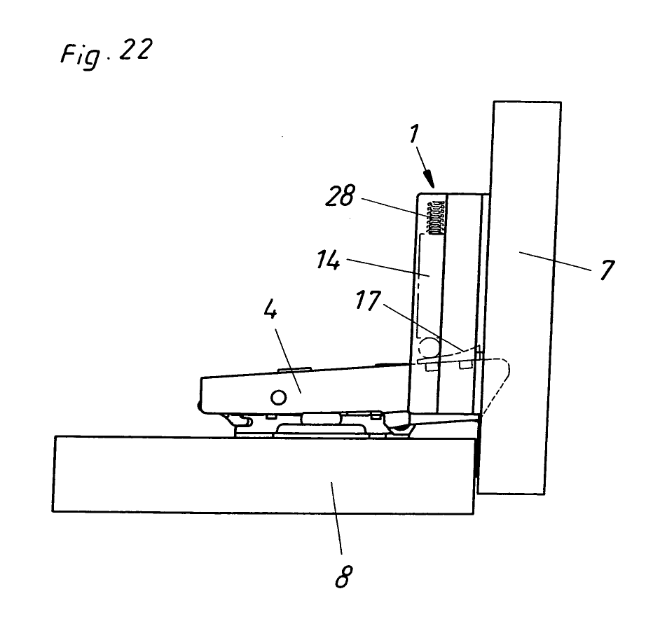

FIG. 22 shows a lateral view of an inventive hinge with attachment attached in the closed position.

In the embodiment shown, the damper 1 is anchored on the hinge cup 3 of a hinge 2. The hinge cup 3 is inserted in a boring in the furniture door 7 and linked via an articulated lever 5 with a hinge arm 4, which is anchored to a base plate 6. The base plate 6 is fixed to a side wall of the body of furniture 8, for example screwed into it.

The damper 1 is in the form of a rotation damper with a rotary piston 12. It comprises a two-part damper housing 9. In one housing part 10 a cylinder chamber 11 is formed, in which the rotary piston 12 of the damper 1 is disposed, and in the second housing part 13 there is a slider 14, which acts as the actuation element. The slider 14 is fitted with an insertion element 15 on which a toothed rack profile 16 is formed. The toothed rack profile 16 could also be formed directly on the slider 14. The insertion element 15 brings purely technical advantages.

The slider 14 runs displaceably in a recess 17 in the housing element 13 and is acted upon by a pressure spring 28. On the end of it which projects out of the damper housing 9, the slider 14 is equipped with a roller body 18, which rolls away along the hinge arm 4 when the furniture door 7 is closing.

The rotary piston 12 runs on an axis 19. At the other end of the axis 19 there is a pinion 20, which in the installation position is taken up into a recess 21 of the slider 14 and meshes with the toothed rack profile 16 of the insertion element 15.

The wing 22 of the rotary piston 12 has a valve which is formed by an opening 23 in the wing 22 and a leaf spring 24. If the rotary piston 12 is rotated in the direction of damping, the leaf spring 24 closes off the opening 23 in the wing 22, and the damping fluid is pressed through the gap between the tip 25 of the wing 22 and the wall 26 of the damper housing 9, as the result of which the desired damping effect is produced. When the furniture door 7 is opened the rotary piston 12 is rotated in the opposite direction, whereupon the leaf spring 24 opens and clears the opening 23, so that the damping fluid can also flow through he opening 23. The pressure spring 28 thereby slides the slider 14 back into the ready position.

The damper housing 9 or the housing element 10 respectively is equipped with a cover 27.

The hinge cup 3 has a flange 29 with an edge 30. In the edge 30 on opposite sides of the flange 29, recesses 31 are formed. The damper housing 9 of the rotary damper 1 has moulded elastic hooks 32 being part of the damper housing 9, which engage in the recesses 31 under the flange 29 when the rotary damper 1 is installed. The rotary damper 1 can thus be mounted without using tools onto the hinge cup 3, by simply pressing it onto the flange 29. Advantageously, the elastic hooks are designed so that the damper housing 9 is also detachable from the flange 29. The damper housing 9 can also be removed from the flange 29 without tools.

Since hinge arms 4 can have various forms, for example there are also cranked hinge arms 4, the invention makes provision for an attachment 17 to be attachable to the hinge arm 4, on which the control surface 21 for the actuation element in the embodiment of the slider 14 is formed. When the door 7 is closing the actuation element presses with its free end on the control surface 21. The control surface 21 describes a curved path, which is adapted to the respective requirements. The control surface 21 can be inclined in opposing directions, and be concave, convex or also straight and angled in form. This allows a specific influencing of the closing characteristics of different hinge types and different closure mechanisms.

The attachment is equipped, for example, with lugs 33 and the hinge arm 4 with holes 34, so that if necessary the attachment 17 can easily be pressed onto the hinge arm 4.

1. Hinge with a hinge cup, which can be inserted into a boring in a furniture part, with a damper housing fixed onto the hinge cup, wherein the damper housing can be fastened onto or removably secured to the hinge cup wherein the damper housing is disposed at least partially outside the boring when the hinge cup is inserted into the boring in the furniture part.

2. Hinge according to claim 1, wherein the damper housing can be fastened onto or removably secured to the hinge cup without tools.

3. Hinge according to claim 1, wherein the damper housing is disposed entirely outside the boring when the hinge cup is inserted into the boring in the furniture part.

4. Hinge according to claim 1, wherein the damper housing comprises hooks by means of which it can be anchored onto the hinge cup.

5. Hinge according to claim 4, wherein the hooks are designed to be elastic.

6. Hinge according to claim 4, wherein the damper housing is made from injected plastic and the hooks are designed all of a piece with the housing.

7. Hinge according to claim 1, wherein a rotary piston with at least one wing runs in the damper housing, wherein the wing with the housing wall, delimits a gap to allow the passage of a damping fluid, wherein the angle of rotation of the rotary piston is limited to a maximum of 360°.

8. Hinge according to claim 7, wherein the angle of rotation of the rotary piston is limited to a maximum of 180°.

9. Hinge according to claim 7, wherein the housing is made in two parts, wherein in one part the rotary piston and in the other part an actuation element is taken up.

10. Hinge according to claim 9, wherein the actuation element is in the form of a slider for the rotary piston.

11. Hinge according to claim 7, wherein the wing of the rotary piston is equipped with a flap.

12. Hinge according to claim 11, wherein the flap is in the form of a leaf spring.

13. Hinge according to claim 1, wherein the hinge cup comprises a flange abutting on the furniture door and wherein the damper housing is anchored on the flange of the hinge cup.

14. Hinge according to claim 13, wherein the flange is fitted with an edge which comprises recesses in which fastening hooks of the damper housing engage.

15. Hinge according to claim 13, wherein the hinge cup is linked articulated with a hinge arm which comprises an attachment, on which a control surface for the actuation element is formed.

16. Hinge according to claim 15, wherein the attachment comprises at least one lug, by means of which it is fixed onto the hinge arm.

17. Hinge according to claim 15, wherein the control surface describes a curved path.

18. Hinge according to claim 15, wherein the attachment is disposed on the end of the hinge arm on which the hinge cup is linked.
